(19) United States
(12) Patent Application Publication
(10) Pub. No.: US 2019/0087930 A1
(43) Pub. Date: Mar. 21, 2019

(54) ADDING METADATA TO TEXTURE SURFACES FOR BANDWIDTH COMPRESSION

(71) Applicant: QUALCOMM Incorporated, San Diego, CA (US)

(72) Inventor: Andrew Evan Gruber, Arlington, MA (US)

(21) Appl. No.: 15/707,608

(22) Filed: Sep. 18, 2017

(51) Int. Cl. G06T 1/60; G06F 12/0875; G06T 7/40; G06T 11/60; G06T 7/11; G06T 1/20

(52) U.S. Cl. CPC G06T 1/60; G06F 12/0875; G06T 7/40; G06F 2212/455; G06T 7/11; G06T 1/20; G06T 11/60

(57) ABSTRACT

A method for memory bandwidth compression comprising analyzing a texture surface to identify one or more areas of the texture surface that are fetchable with lower memory bandwidth consumption as compared to other areas of the texture surface, adding metadata to a metadata surface associated with the texture surface based on the analysis, the metadata indicating the one or more areas of the texture surface that are fetchable with lower memory bandwidth consumption as compared to other areas of the texture surface, and fetching the texture surface in accordance with the metadata.

### TECHNICAL FIELD

This disclosure relates to techniques for graphics processing, and more specifically to techniques for memory bandwidth compression for texture surfaces.

### BACKGROUND

Visual content for display, such as content for graphical user interfaces and video games, may be generated by a graphics processing unit (GPU). A GPU may convert two-dimensional or three-dimensional (3D) objects into a two-dimensional (2D) pixel representation that may be displayed. Converting information about 3D objects into a bitmap that can be displayed is known as pixel rendering, and requires considerable memory and processing power. In the past, 3D graphics capability was available only on powerful workstations. However, now 3D graphics accelerators are commonly found in personal computers (PC), as well as in in embedded devices, such as smart phones, tablet computers, portable media players, portable video gaming consoles, and the like. Typically, embedded devices have less computational power and memory capacity as compared to conventional PCs. As such, increased complexity in 3D graphics rendering techniques presents difficulties when implementing such techniques on an embedded system. Other tasks performed by GPUs include filtering tasks for image processing. Such filtering tasks are typically hardware and memory-intensive, particularly for GPUs operating in a mobile environment.

Graphics processing techniques may also include texture mapping. In texture mapping, a GPU may apply textures (e.g., 2D images) to the polygons or surfaces being rendered. The memory bandwidth used to access texture data (e.g., texture surfaces) consumes a large portion of the memory bandwidth in graphics rendering, due to the typically large sizes of texture surfaces. Memory bandwidth is often a limiting factor in graphics performance, both in terms of speed and power.

### SUMMARY

This disclosure describes techniques for lowering the memory bandwidth consumed when a GPU accesses texture surfaces from a system memory. The techniques of this disclosure include the generation of metadata stored in a metadata surface corresponding to existing texture surfaces. The generated metadata indicates areas of uniformity and/or low frequency in the texel data of the texture surface that may be fetched with lower bandwidth consumption. The original texture surface is left unmodified in memory, and the generated metadata may be used or ignored during a texture fetch without affecting the functional correctness of any texture data that is fetched.

In some examples, the metadata may indicate certain areas of a texture surface that are the same (or very close to the same) as other areas of the texture surface. A GPU may use the metadata to determine if certain areas of a texture surface need to be fetched. In one example, the metadata may indicate that a second area of the texture surface is the same as a first area of the texture surface. The GPU may then determine if the first area of the texture surface is already stored in a texture cache of the GPU. If yes, the second area of the texture surface need not be fetched from system memory, thus saving memory bandwidth consumption. If no, the second area of the texture surface is fetched from system memory.

In one example of the disclosure, a method for memory bandwidth compression comprises analyzing a texture surface to identify one or more areas of the texture surface that are fetchable with lower memory bandwidth consumption as compared to other areas of the texture surface, adding metadata to a metadata surface associated with the texture surface based on the analysis, the metadata indicating the one or more areas of the texture surface that are fetchable with lower memory bandwidth consumption as compared to other areas of the texture surface, and fetching the texture surface in accordance with the metadata.

In another example of the disclosure, an apparatus comprises a system memory configured to store a texture surface and a metadata surface associated with the texture surface, a processor in communication with the system memory, the processor configured to analyze the texture surface to identify one or more areas of the texture surface that are fetchable with lower memory bandwidth consumption as compared to other areas of the texture surface, and add metadata to the metadata surface associated with the texture surface based on the analysis, the metadata indicating the one or more areas of the texture surface that are fetchable with lower memory bandwidth consumption as compared to other areas of the texture surface, and a graphics processing unit in communication with the processor and the system memory, the graphics processing unit configured to fetch the texture surface in accordance with the metadata.

In another example of the disclosure, an apparatus comprises means for analyzing a texture surface to identify one or more areas of the texture surface that are fetchable with lower memory bandwidth consumption as compared to other areas of the texture surface, means for adding metadata to a metadata surface associated with the texture surface based on the analysis, the metadata indicating the one or more areas of the texture surface that are fetchable with lower memory bandwidth consumption as compared to other areas of the texture surface, and means for fetching the texture surface in accordance with the metadata.

In another example, this disclosure describes a computer-readable storage medium storing instructions that, when executed, cause one or more processors to analyze a texture surface to identify one or more areas of the texture surface that are fetchable with lower memory bandwidth consumption as compared to other areas of the texture surface, add metadata to a metadata surface associated with the texture surface based on the analysis, the metadata indicating the one or more areas of the texture surface that are fetchable with lower memory bandwidth consumption as compared to other areas of the texture surface, and fetch the texture surface in accordance with the metadata.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram showing an example computing device configured to perform the techniques of this disclosure.

FIG. 2 is a block diagram showing components of FIG. 1 in more detail.

FIG. 3 is a conceptual diagram showing a texture surface divided into regions and chunks.

FIG. 4 is a conceptual diagram showing example texture chunks and corresponding metadata.

FIG. 5 is a flowchart showing an example method of the disclosure.

FIG. 6 is a flowchart showing another example method of the disclosure.

### DETAILED DESCRIPTION

Graphics processing techniques include texture mapping. In texture mapping, a graphics processor may apply textures (e.g., 2D images) to the polygons or surfaces being rendered. The memory bandwidth used to access texture data (e.g., a texture surface) consumes a large portion of the memory bandwidth in graphics rendering, due to the typically large sizes of texture surfaces. Memory bandwidth is often a limiting factor in graphics performance, both in terms of speed and power.

In some examples, the texel (texture element) data of texture surfaces are compressed, resulting in a smaller file size for the texture surfaces. In this context, texture compression is a form of image compression designed to reduce the memory size needed to store texture surfaces. Example texture compression techniques include S3 Texture Compression (S3TC), Power VR Texture Compression (PVRTC), Ericsson Texture Compression (ETC), and Adaptive Scalable Texture Compression (ASTC). While texture surfaces are typically compressed, the texture compression technique used is often a uniform texture compression. That is, all areas of the texture are compressed using the same compression ratio. Such uniform compression may lead to unnecessary bandwidth being consumed in uniform or low-frequency regions of the texture surface.

In some examples, non-uniform texture compression may be applied to a texture surface. For non-uniform bandwidth compression, different regions of a texture surface may be compressed at different compression ratios. Non-uniform bandwidth compression may use a metadata surface (i.e., metadata information that describes how the compression is applied to different areas of the texture). Some example non-uniform texture compression techniques are lossless. As such, such lossless non-uniform texture compression techniques tend to achieve worse overall compression than existing lossy texture compression formats.

This disclosure describes techniques for lowering the memory bandwidth consumed when a GPU accesses texture surfaces from a system memory. The techniques of this disclosure include the generation of metadata stored in a metadata surface corresponding to existing texture surfaces. The generated metadata indicates areas of uniformity and/or low frequency in the texel data of the texture surface that may be fetched with lower memory bandwidth consumption as compared to other areas of the texture surface.

The metadata generation and texture fetching techniques of this disclosure do not change any of the data in the underlying texture surface. As such, the techniques of this disclosure are different than the texture compression techniques discussed above that are based on image compression (e.g., S3TC, ETC, etc.). Rather, the techniques of this disclosure may be considered memory bandwidth compression techniques. That is, the file size of an underlying texture surface remains the same. However, the techniques of this disclosure may reduce the number of memory fetches needed to fetch a texture surface from a system memory to a texture cache of a GPU. The techniques of this disclosure may be applied to both compressed texture surfaces and uncompressed texture surfaces.

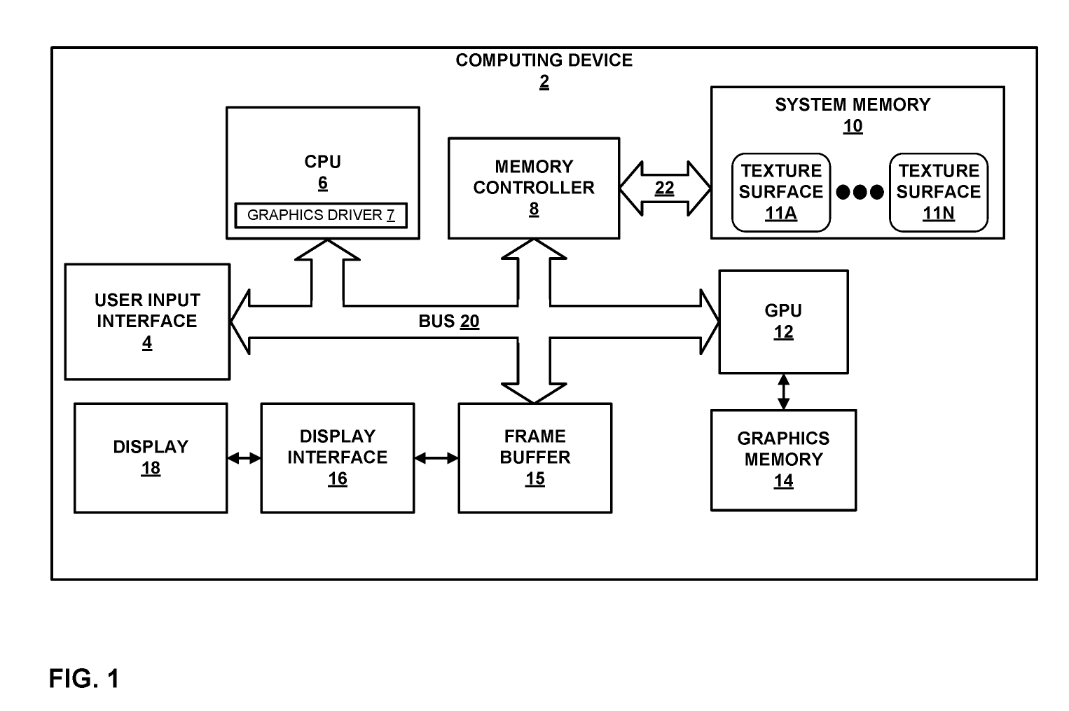

FIG. 1 is a block diagram illustrating an example computing device 2 that may be used to implement the techniques of this disclosure for memory bandwidth compression for texture surfaces. Computing device 2 may comprise, for example, a personal computer, a desktop computer, a laptop computer, a tablet computer, a computer workstation, a video game platform or console, a mobile telephone such as, e.g., a cellular or satellite telephone, a landline telephone, an Internet telephone, a handheld device such as a portable video game device or a personal digital assistant (PDA), a personal music player, a video player, a display device, a television, a television set-top box, a server, an intermediate network device, a mainframe computer, any mobile device, or any other type of device that processes and/or displays graphical data.

As illustrated in the example of FIG. 1, computing device 2 may include user input interface 4, central processing unit (CPU) 6, memory controller 8, system memory 10, GPU 12, graphics memory 14, display interface 16, display 18 and buses 20 and 22. Note that in some examples, graphics memory 14 may be “on-chip” with GPU 12. In some cases, CPU 6, memory controller 8, GPU 12, and graphics memory 14, and possibly display interface 16 shown in FIG. 1 may be on-chip, for example, in a system on a chip (SoC) design. User input interface 4, CPU 6, memory controller 8, GPU 12 and display interface 16 may communicate with each other using bus 20. Memory controller 8 and system memory 10 may also communicate with each other using bus 22. Buses 20, 22 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXensible Interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. Additionally, CPU 6 may execute graphics driver 7 for controlling the operation of GPU 12. The user may provide input to computing device 2 via one or more input devices (not shown) such as a keyboard, a mouse, a microphone, a touch pad or another input device that is coupled to computing device 2 via user input interface 4.

The software applications that execute on CPU 6 may include one or more graphics rendering instructions that instruct GPU 12 to cause the rendering of graphics data to display 18. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, or any other public or proprietary standard graphics API. In order to process the graphics rendering instructions, CPU 6 may issue one or more graphics rendering commands to GPU 12 (e.g., through graphics driver 7) to cause GPU 12 to perform some or all of the rendering of the graphics data. In some examples, the graphics data to be rendered may include a list of graphics primitives, e.g., points, lines, triangles, quadrilaterals, triangle strips, etc.

In other examples, the software instructions that execute on CPU 6 may cause GPU 12 to execute a general-purpose shader for performing more general computations applicable to be executed by the highly parallel nature of GPU hardware. Such general-purpose applications may be a so-called general-purpose graphics processing unit (GPGPU) and may conform to a general-purpose API, such as OpenCL

Memory controller 8 facilitates the transfer of data going into and out of system memory 10. For example, memory controller 8 may receive memory read and write commands, and service such commands with respect to system memory 10 in order to provide memory services for the components in computing device 2. Memory controller 8 is communicatively coupled to system memory 10 via memory bus 22. Although memory controller 8 is illustrated in FIG. 1 as being a processing module that is separate from GPU 12, CPU 6 and system memory 10, in other examples, some or all of the functionality of memory controller 8 may be implemented on one or more of GPU 12, CPU 6 and system memory 10.

System memory 10 may store program modules and/or instructions that are accessible for execution by CPU 6 and/or data for use by the programs executing on CPU 6. For example, system memory 10 may store a window manager application that is used by CPU 6 to present a graphical user interface (GUI) on display 18. In addition, system memory 10 may store user applications and application surface data associated with the applications. System memory 10 may additionally store information for use by and/or generated by other components of computing device 2. For example, system memory 10 may act as a device memory for GPU 12 and may store data to be operated on by GPU 12 as well as data resulting from operations performed by GPU 12. For example, system memory 10 may store any combination of depth buffers, stencil buffers, vertex buffers, frame buffers, or the like. System memory 10 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data media or an optical storage media.

In addition, system memory 10 may store texture surfaces 11A-11N (“texture surfaces 11”). Each of texture surfaces 11A-11N may comprise texture elements, also referred to as texels. Each of texture surfaces 11A-11N may be, but is not necessarily limited to, a one-dimensional, two-dimensional, or three-dimensional texture, or a one-dimensional, two-dimensional, or three-dimensional array of textures. In one example, a particular texture surface (e.g., texture surface 11A) of texture surfaces 11 may include an array of texels which contain color and alpha values for the texture surface.

GPU 12 may be configured to fetch one or more of texture surfaces 11 from system memory 10 and store at least a portion of the texture surface in a texture cache of GPU 12. GPU 12 may then use the texture surface to perform texture filtering and/or texture mapping as part of a rendering process.

As will be explained in more detail below, system memory 10 may be configured to store texture surface 11A and a metadata surface associated with the texture surface 11A. CPU 6, executing graphics driver 7, may be configured to analyze texture surface 11A to identify one or more areas of texture surface 11A that are fetchable with lower memory bandwidth consumption as compared to other areas of texture surface 11A. For example, lower memory bandwidth consumption may mean fewer transfers of texture data from system memory 10 to GPU 12 through bus 22 and bus 20. CPU 6 may be further configured to add metadata to a metadata surface associated with the texture surface 11A based on the analysis. The metadata indicates the one or more areas of texture surface 11A that are fetchable with lower memory bandwidth consumption. GPU 12 may be configured to fetch the texture surface 11A in accordance with the metadata.

GPU 12 may be further configured to perform graphics operations to render one or more graphics primitives to display 18. Thus, when one of the software applications executing on CPU 6 requests graphics processing, CPU 6 may provide graphics commands and graphics data to GPU 12 for rendering to display 18. The graphics data may include, e.g., drawing commands, state information, primitive information, texture surfaces, etc. GPU 12 may, in some instances, be built with a highly-parallel structure that provides more efficient processing of complex graphic-related operations than CPU 6. For example, GPU 12 may include a plurality of processing elements that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 18 more quickly than drawing the scenes directly to display 18 using CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. GPU 12 may include one or more processors, such as one or more microprocessors, application specific integrated circuits (ASICs), field programmable gate arrays (FPGAs), digital signal processors (DSPs), or other equivalent integrated or discrete logic circuitry.

GPU 12 may be directly coupled to graphics memory 14. Thus, GPU 12 may read data from and write data to graphics memory 14 without using bus 20. In other words, GPU 12 may process data locally using a local storage, instead of off-chip memory. This allows GPU 12 to operate in a more efficient manner by eliminating the need of GPU 12 to read and write data via bus 20, which may experience heavy bus traffic. In some instances, however, GPU 12 may not include a separate memory, but instead utilize system memory 10 via bus 20. Graphics memory 14 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media.

CPU 6 and/or GPU 12 may store rendered image data in a frame buffer 15. Frame buffer 15 may be an independent memory or may be allocated within system memory 10. Display interface 16 may retrieve the data from frame buffer 15 and configure display 18 to display the image represented by the rendered image data. In some examples, display interface 16 may include a digital-to-analog converter (DAC) that is configured to convert the digital values retrieved from the frame buffer into an analog signal consumable by display 18. In other examples, display interface 16 may pass the digital values directly to display 18 for processing. Display 18 may include a monitor, a television, a projection device, a liquid crystal display (LCD), a plasma display panel, a light emitting diode (LED) array, such as an organic LED (OLED) display, a cathode ray tube (CRT) display, electronic paper, a surface-conduction electron-emitted display (SED), a laser television display, a nanocrystal display or another type of display unit. Display 18 may be integrated within computing device 2. For instance, display 18 may be a screen of a mobile telephone. Alternatively, display 18 may be a stand-alone device coupled to computing device 2 via a wired or wireless communications link. For instance, display 18 may be a computer monitor or flat panel display connected to a personal computer via a cable or wireless link.

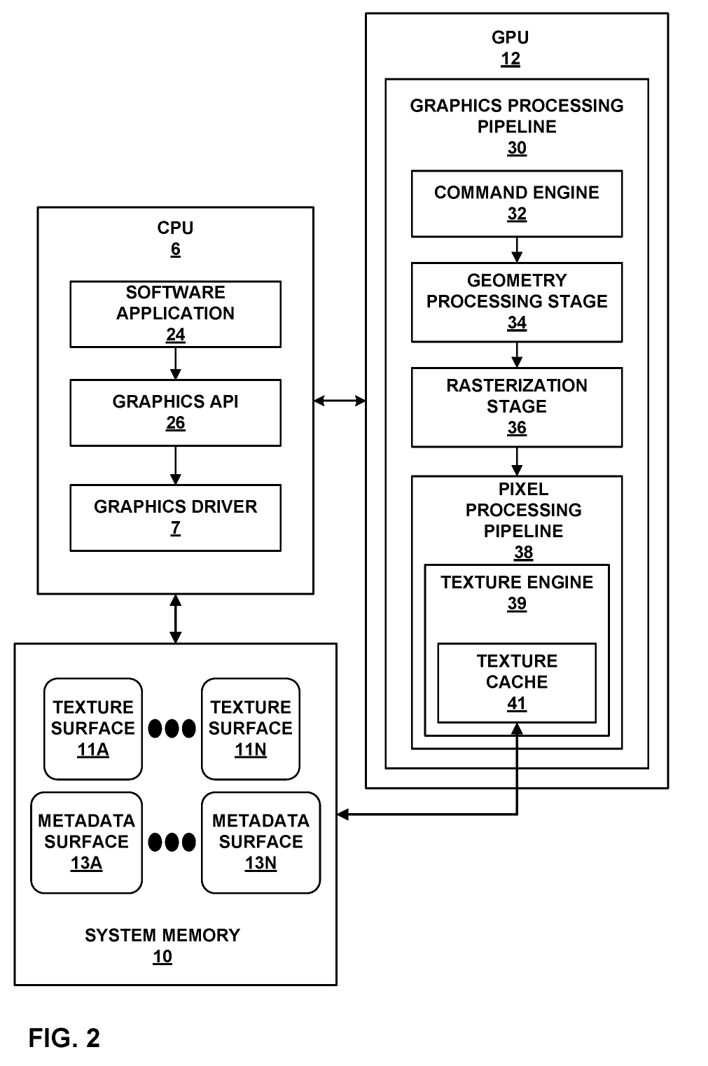

FIG. 2 is a block diagram illustrating example implementations of CPU 6, GPU 12, and system memory 10 of FIG. 1 in further detail. CPU 6 may include at least one software application 24, graphics API 26, and graphics driver 7, each of which may be one or more software applications or services that execute on CPU 6. GPU 12 may include graphics processing pipeline 30 that includes a plurality of graphics processing stages that operate together to execute graphics processing commands. GPU 12 may be configured to execute graphics processing pipeline 30 in a variety of rendering modes, including a binning rendering mode and a direct rendering mode. As shown in FIG. 2, graphics processing pipeline 30 may include command engine 32, geometry processing stage 34, rasterization stage 36, and pixel processing pipeline 38. Pixel processing pipeline 38 may include texture engine 39 and texture cache 41. Each of the components in graphics processing pipeline 30 may be implemented as fixed-function components, programmable components (e.g., as part of a shader program executing on a programmable shader unit), or as a combination of fixed-function and programmable components. Memory available to both CPU 6 and GPU 12 may include system memory 10.

Software application 24 may be any application that utilizes the functionality of GPU 12. For example, software application 24 may be a graphical user interface (GUI) application, an operating system, a portable mapping application, a computer-aided design program for engineering or artistic applications, a video game application, or another type of software application that may utilize a GPU.

Software application 24 may include one or more drawing instructions that instruct GPU 12 to render a GUI and/or a graphics scene. For example, the drawing instructions may include instructions that define a set of one or more graphics primitives to be rendered by GPU 12. In some examples, the drawing instructions may, collectively, define all or part of a plurality of windowing surfaces used in a GUI. In additional examples, the drawing instructions may, collectively, define all or part of a graphics scene that includes one or more graphics objects within a model space or world space defined by the application.

Software application 24 may invoke graphics driver 7, via graphics API 26, to issue one or more commands to GPU 12 for rendering one or more graphics primitives into displayable graphics images. For example, software application 24 may invoke graphics driver 7, via graphics API 26, to provide primitive definitions to GPU 12. In some instances, the primitive definitions may be provided to GPU 12 in the form of a list of drawing primitives, e.g., triangles, rectangles, triangle fans, triangle strips, etc. The primitive definitions may include vertex specifications that specify one or more vertices associated with the primitives to be rendered. The vertex specifications may include positional coordinates for each vertex and, in some instances, other attributes associated with the vertex, such as, e.g., color coordinates, normal vectors, and texture coordinates. The primitive definitions may also include primitive type information (e.g., triangle, rectangle, triangle fan, triangle strip, etc.), scaling information, rotation information, and the like. Based on the instructions issued by software application 24 to graphics driver 7, graphics driver 7 may formulate one or more commands that specify one or more operations for GPU 12 to perform in order to render the primitive. When GPU 12 receives a command from CPU 6, graphics processing pipeline 30 decodes the command and configures one or more processing elements within graphics processing pipeline 30 to perform the operation specified in the command. After performing the specified operations, graphics processing pipeline 30 outputs the rendered data to frame buffer 15 of FIG. 1 associated with a display device. Graphics processing pipeline 30 may be configured to execute in one of a plurality of different rendering modes, including a binning rendering mode and a direct rendering mode.

Graphics driver 7 may be further configured to compile one or more shader programs, and to download the compiled shader programs onto one or more programmable shader units contained within GPU 12. The shader programs may be written in a high-level shading language, such as, e.g., an OpenGL Shading Language (GLSL), a High-Level Shading Language (HLSL), a C for Graphics (Cg) shading language, etc. The compiled shader programs may include one or more instructions that control the operation of a programmable shader unit within GPU 12. For example, the shader programs may include vertex shader programs and/or pixel shader programs. A vertex shader program may control the execution of a programmable vertex shader unit or a unified shader unit, and include instructions that specify one or more per-vertex operations. A pixel shader program may include pixel shader programs that control the execution of a programmable pixel shader unit or a unified shader unit, and include instructions that specify one or more per-pixel operations.

Graphics processing pipeline 30 may be configured to receive one or more graphics processing commands from CPU 6, via graphics driver 7, and to execute the graphics processing commands to generate displayable graphics images. As discussed above, graphics processing pipeline 30 includes a plurality of stages that operate together to execute graphics processing commands. It should be noted, however, that such stages need not necessarily be implemented in separate hardware blocks. For example, portions of geometry processing stage 34 and pixel processing pipeline 38 may be implemented as part of a unified shader unit. Again, graphics processing pipeline 30 may be configured to execute in one of a plurality of different rendering modes, including a binning rendering mode and a direct rendering mode.

Command engine 32 may receive graphics processing commands and configure the remaining processing stages within graphics processing pipeline 30 to perform various operations for carrying out the graphics processing commands. The graphics processing commands may include, for example, drawing commands and graphics state commands. The drawing commands may include vertex specification commands that specify positional coordinates for one or more vertices and, in some instances, other attribute values associated with each of the vertices, such as, e.g., color coordinates, normal vectors, texture coordinates and fog coordinates. The graphics state commands may include primitive type commands, transformation commands, lighting commands, etc. The primitive type commands may specify the type of primitive to be rendered and/or how the vertices are combined to form a primitive. The transformation commands may specify the types of transformations to perform on the vertices. The lighting commands may specify the type, direction and/or placement of different lights within a graphics scene. Command engine 32 may cause geometry processing stage 34 to perform geometry processing with respect to vertices and/or primitives associated with one or more received commands.

Geometry processing stage 34 may perform per-vertex operations and/or primitive setup operations on one or more vertices in order to generate primitive data for rasterization stage 36. Each vertex may be associated with a set of attributes, such as, e.g., positional coordinates, color values, a normal vector, and texture coordinates. Geometry processing stage 34 modifies one or more of these attributes according to various per-vertex operations. For example, geometry processing stage 34 may perform one or more transformations on vertex positional coordinates to produce modified vertex positional coordinates. Geometry processing stage 34 may, for example, apply one or more of a modeling transformation, a viewing transformation, a projection transformation, a ModelView transformation, a ModelViewProjection transformation, a viewport transformation and a depth range scaling transformation to the vertex positional coordinates to generate the modified vertex positional coordinates. In some instances, the vertex positional coordinates may be model space coordinates, and the modified vertex positional coordinates may be screen space coordinates. The screen space coordinates may be obtained after the application of the modeling, viewing, projection and viewport transformations. In some instances, geometry processing stage 34 may also perform per-vertex lighting operations on the vertices to generate modified color coordinates for the vertices. Geometry processing stage 34 may also perform other operations including, e.g., normal transformations, normal normalization operations, view volume clipping, homogenous division and/or backface culling operations.

Geometry processing stage 34 may produce primitive data that includes a set of one or more modified vertices that define a primitive to be rasterized as well as data that specifies how the vertices combine to form a primitive. Each of the modified vertices may include, for example, modified vertex positional coordinates and processed vertex attribute values associated with the vertex. The primitive data may collectively correspond to a primitive to be rasterized by further stages of graphics processing pipeline 30. Conceptually, each vertex may correspond to a corner of a primitive where two edges of the primitive meet. Geometry processing stage 34 may provide the primitive data to rasterization stage 36 for further processing. In some examples, all or part of geometry processing stage 34 may be implemented by one or more shader programs executing on one or more shader units. For example, geometry processing stage 34 may be implemented, in such examples, by a vertex shader, a geometry shader or any combination thereof. In other examples, geometry processing stage 34 may be implemented as a fixed-function hardware processing pipeline or as a combination of fixed-function hardware and one or more shader programs executing on one or more shader units.

Rasterization stage 36 is configured to receive, from geometry processing stage 34, primitive data that represents a primitive to be rasterized, and to rasterize the primitive to generate a plurality of source pixels that correspond to the rasterized primitive. In some examples, rasterization stage 36 may determine which screen pixel locations are covered by the primitive to be rasterized, and generate a source pixel for each screen pixel location determined to be covered by the primitive. Rasterization stage 36 may determine which screen pixel locations are covered by a primitive by using techniques known to those of skill in the art, such as, e.g., an edge-walking technique, evaluating edge equations, etc. Rasterization stage 36 may provide the resulting source pixels to pixel processing pipeline 38 for further processing.

The source pixels generated by rasterization stage 36 may correspond to a screen pixel location, e.g., a destination pixel, and be associated with one or more color attributes. All of the source pixels generated for a specific rasterized primitive may be said to be associated with the rasterized primitive. The pixels that are determined by rasterization stage 36 to be covered by a primitive may conceptually include pixels that represent the vertices of the primitive, pixels that represent the edges of the primitive and pixels that represent the interior of the primitive.

Pixel processing pipeline 38 is configured to receive a source pixel associated with a rasterized primitive, and to perform one or more per-pixel operations on the source pixel. Per-pixel operations that may be performed by pixel processing pipeline 38 include, e.g., alpha test, texture mapping, color computation, pixel shading, per-pixel lighting, fog processing, blending, a pixel ownership test, a source alpha test, a stencil test, a depth test, a scissors test and/or stippling operations. In addition, pixel processing pipeline 38 may execute one or more pixel shader programs to perform one or more per-pixel operations. The resulting data produced by pixel processing pipeline 38 may be referred to herein as destination pixel data and stored in frame buffer 15. The destination pixel data may be associated with a destination pixel in frame buffer 15 that has the same display location as the source pixel that was processed. The destination pixel data may include data such as, e.g., color values, destination alpha values, depth values, etc.

Texture engine 39 may be included as part of pixel processing pipeline 38. Texture engine 39 may include both programmable and fixed function hardware designed to apply textures (texels) to pixels. Texture engine 39 may include dedicated hardware for performing texture filtering, whereby one or more texel values are multiplied by one or more pixel values and accumulated to produce the final texture mapped pixel. Texture engine 39 may include a texture cache 41 to store one or more portions of a texture surface (e.g., texture surfaces 11). As will be explained in more detail below, GPU 12 may be configured to fetch a texture surface (e.g., texture surface 11A) based on metadata stored in a corresponding metadata surface (e.g., metadata surface 13A).

In accordance with one example of this disclosure, CPU 6, through the execution of graphics driver 7, may be configured to analyze one or more of texture surfaces 11 to identify one or more areas of the respective texture surface that are fetchable with lower memory bandwidth consumption as compared to other areas. In general, graphics driver 7 may include instructions that cause CPU 6 to analyze the texel data in texture surface 11A and determine if particular areas of texture surface 11A are uniform or include low frequency changes relative to other areas of the texture surface. In some examples, CPU 6 may analyze texture surface 11A by comparing adjacent areas of texture surface 11A (e.g., areas of the texture surface directly next to each other) to identify uniform or low frequency areas. In other examples, CPU 6 may be configured to analyze texture surface 11A by comparing any area of texture surface 11A to any other area of the texture surface 11A (e.g., by comparing non-adjacent areas).

In one example of the disclosure, CPU 6 may be configured to identify that a particular area of texture surface 11A is uniform relative to another area of texture surface 11A if the areas of texture surface 11A are exactly the same. That is, the texel values in one area of texture surface 11A are exactly the same as texel values in another area of texture surface 11A.

In another example of the disclosure, CPU 6 may be configured to identify that a particular area of texture surface 11A is uniform or generally low frequency relative to another area of texture surface 11A if the areas of texture surface 11A have texel values that are close in value relative to some predetermined threshold. That is, the texel values in one area of texture surface 11A are not exactly the same as the texel values in another area of texture surface 11A, but are close to the same value. For example, CPU 6 may be configured to calculate a sum of absolute differences (SAD) between two areas of texture surface 11A. If the SAD is lower than some predetermined threshold, CPU 6 may be configured to identify that the particular areas of texture surface 11A are uniform. However, any techniques for determining the relative closeness in values between two areas of a texture surface may be used.

Based on the analysis, CPU 6 may be configured to add metadata to a metadata surface (e.g., metadata surfaces 13A-13N) corresponding to the analyzed texture surface. Metadata surfaces 13A-13N are data structures that each correspond to a particular texture surface. Since metadata surfaces 13A-13N are additional data structures relative to texture surfaces 11, the underlying texel data of texture surfaces 11 are unchanged by the metadata generation process. The metadata includes indications for one or more areas of a particular texture surface (e.g., texture surface 11A). The metadata indications are data values that indicate that certain areas of the texture surface 11 are fetchable with lower memory bandwidth consumption. For example, metadata in metadata surface 13A may indicate which areas of texture surface 11A have been identified as being the same or nearly the same. The metadata indications may be pointers, instructions, or any other indications that instruct GPU 12 how to fetch the texture surface 11.

For example, if GPU 12 has previously fetched an area of texture surface 11A that is indicated by the metadata in metadata surface 13A as being the same as another area that has yet to be fetched, GPU 12 may use the metadata to identify that the texture data already in the texture cache 41 is the same as another region that needs to be fetched. In this case, GPU 12 need not fetch the other area, thus saving memory bandwidth.

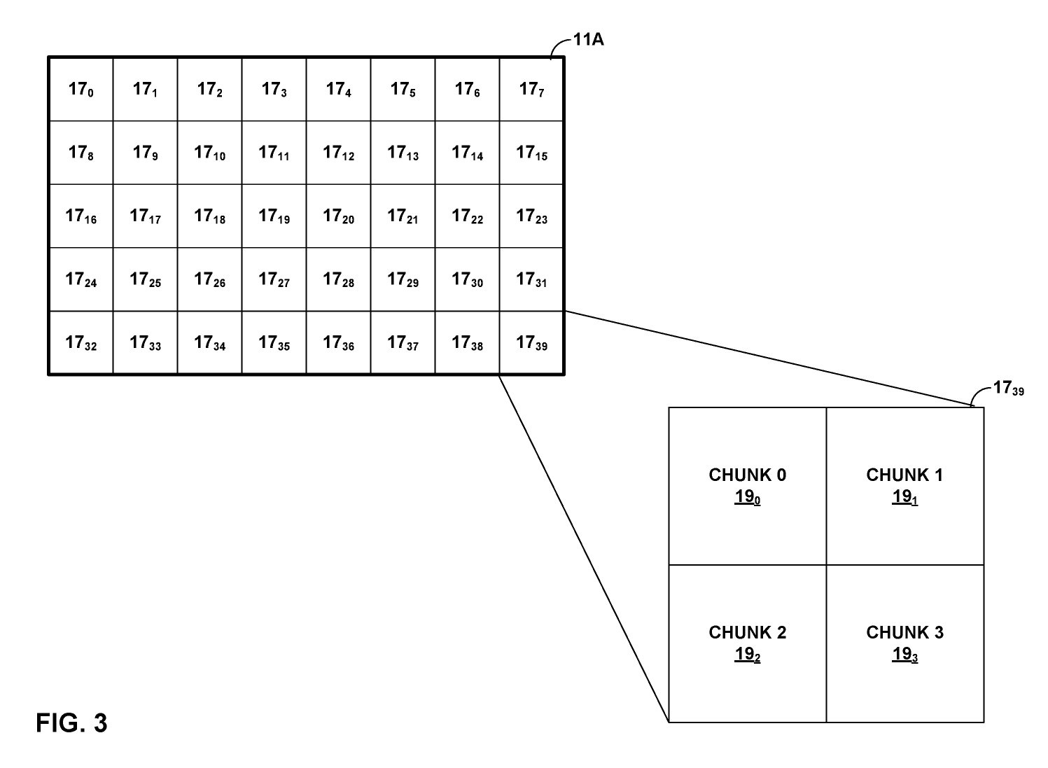

In a more specific example of the disclosure, CPU 6, through the execution of graphics driver 7, may be configured to divide a texture surface (e.g., texture surface 11A) into a plurality of regions and chunks. FIG. 3 is a conceptual diagram showing a texture surface divided into regions and chunks. In this example, the one or more areas of the texture surface that are fetchable with lower memory bandwidth consumption as compared to other areas of the texture surface include one or more the of the plurality of chunks in the regions of texture surface 11A. As shown in FIG. 3, CPU 6 is configured to divide texture surface 11A into a plurality of regions 17₀-17₃₉ (“regions 17”). Each of regions 17 may be further divided into a 2×2 arrangement of four chunks. As shown in FIG. 3, region 17₃₉ is divided into chunks 19₀, 19₁, 19₂, and 19₃ (“chunks 19”). The size of the regions and chunks may be any size desired. In one example, the size a single chunk may be set to be equal to or less than a texture cache line size of texture cache 41 of FIG. 2. In some examples, 64 bytes may be a typical texture cache line size. As such, each of chunks 19 may be 64 bytes of texel data. Note that this may be 64 bytes of compressed texel data or 64 bytes of uncompressed texel data. In this example, regions 17 would each include 256 bytes of texel data.

In the example of FIG. 3, CPU 6 may be configured to analyze each of regions 17 within texture surface 11A to identify regions of uniformity or low frequency between the chunks in one specific region. For example, CPU 6 may be configured to analyze chunks 19 in region 17₃₉ to determine which of the chunks may be fetched using lower memory bandwidth consumption. CPU 6 would then generate the metadata based on the analysis.

In one example of the disclosure, the metadata for each chunk of a region is a 2-bit value that serves as a pointer to a particular chunk in the region. GPU 12 may access the metadata and then fetch the chunks of texels within the region of the texture surface based on this pointer. Given a 64-byte chunk, the addition of a 2-bit metadata value for each chunk represents an additional bandwidth/storage cost of only 0.5%, while potentially saving up to 22% in texture bandwidth.

The following is an example of metadata values that may be used as pointers to chunks within a region. However, other metadata values may be used. A metadata value of 00 may indicate to fetch the current chunk as is. That is, GPU 12 will fetch the current chunk having a metadata value of 00 from a system memory location associated with the current chunk. A metadata value of 01 for the current chunk may indicate to fetch the chunk horizontally next to the current chunk. That is, GPU 12 will fetch the current chunk having a metadata value of 01 from the system memory location associated with a chunk horizontally next to the current chunk. A metadata value of 10 for a current chunk may indicate to fetch the chunk vertically next to the current chunk. That is, GPU 12 will fetch the current chunk having a metadata value of 10 from the system memory location associated with a chunk vertically next to the current chunk. A metadata value of 11 for the current chunk may indicate to fetch the chunk diagonally relative to the current chunk. That is, GPU 12 will fetch the current chunk having a metadata value of 11 from the system memory location associated with a chunk diagonally next to the current chunk.

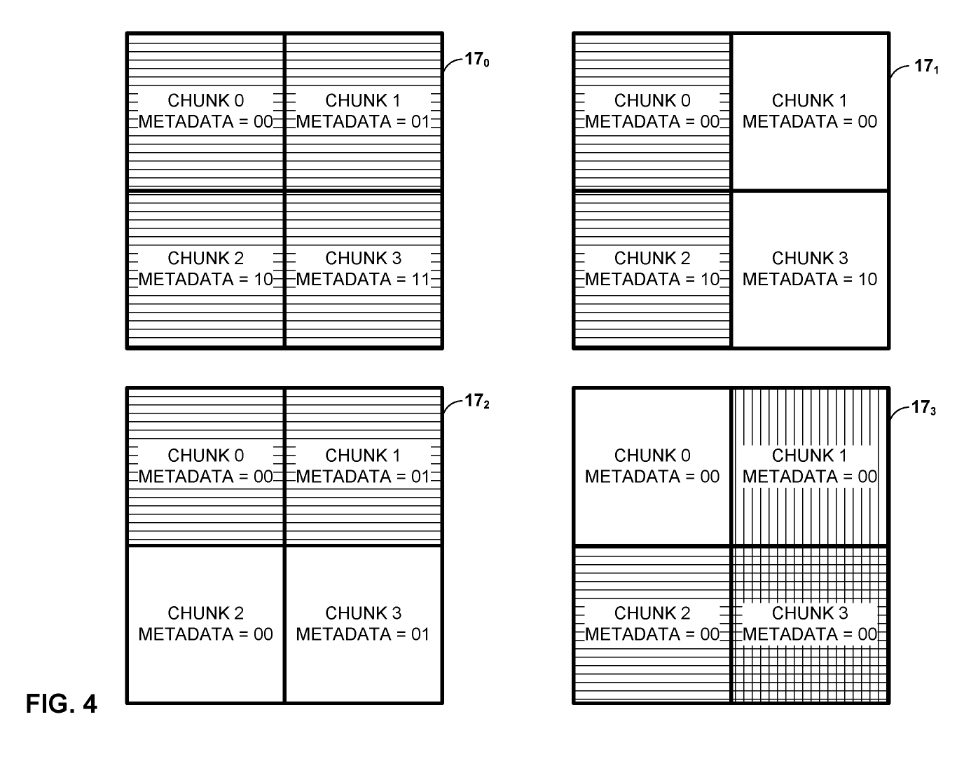

FIG. 4 is a conceptual diagram showing example texture chunks and corresponding metadata. Region 17₀ includes four chunks all having the same texel values. In the example of FIG. 4, it is assumed that CPU 6 analyzes the chunks in raster scan order: chunk 0→chunk 1→chunk 2→chunk 3. However, any order of analysis may be used. CPU 6 assigns metadata value 00 to the metadata surface associated with chunk 0 of region 17₀. This metadata value indicates that GPU 12 should fetch chunk 0 of region 17₀ from the system memory location associated with chunk 0.

CPU 6 then analyzes chunk 1 of region 17₀ and determines that chunk 1 is the same as chunk 0. CPU 6 may then assign a metadata value of 01 to the metadata surface associated with chunk 1 of region 17₀. This metadata value indicates that GPU 12 should fetch chunk 1 of region 17₀ from the system memory location associated with chunk 0. As will discussed in more detail below, GPU 12, based on this metadata value, may determine that chunk 1 need not be fetched since the texel values of chunk 0 may have been previously fetched into texture cache 41 (see FIG. 2). Because the system memory locations for both chunk 0 and chunk 1 are the same, as indicated by the metadata value for chunk 1, chunk 1 need not be fetched. As such, memory bandwidth consumption is reduced. In some examples, chunk 1 is fetched prior to chunk 0 (e.g., an order other than a raster scan order is used). In this example, when fetching chunk 0, GPU 12 may reuse data that was already fetched when processing chunk 1. As such, memory bandwidth savings may be achieved regardless of the rasterization order within a particular region.

CPU 6 then analyzes chunk 2 of region 17₀ and determines that chunk 2 is the same as either chunk 0 or chunk 1. CPU 6 may then assign a metadata value of 10 or 11 to the metadata surface associated with chunk 2 of region 17₀, as the texel values for chunk 2 may be accessed from either the system memory locations of chunk 0 or chunk 1. As chunk 1 was already indicated as being fetchable from the memory location of chunk 0, it would be preferable to indicate that chunk 2 may be accessed from the memory location of chunk 0, so as to reuse the texels already fetched for chunk 0. As such, CPU 6 would be configured to generate metadata value of 10 for chunk 2. This metadata value indicates that GPU 12 should fetch chunk 2 of region 17₀ from the system memory location associated with chunk 0.

CPU 6 then analyzes chunk 3 of region 17₀ and determines that chunk 3 is the same as chunk 0. CPU 6 may then assign a metadata value of 11 to the metadata surface associated with chunk 3 of region 17₀. This metadata value indicates that GPU 12 should fetch chunk 3 of region 17₀ from the system memory location associated with chunk 0.

In the example of region 17₀, the metadata indicates that each of chunk 1, chunk 2, and chunk 3, is the same as chunk 0. As such, GPU 12 may use the metadata to only fetch chunk 0, and skip fetching the other chunks. As such, a 4:1 memory bandwidth compression is achieved.

Region 17₁ and region 17₂ show examples of vertical and horizontal compression. In the example region 17₁, the left-side chunks 0 and 2 have the same texel values, while the right-side chunks 1 and 3 have the same texel values. As such, CPU 6, when analyzing region 17₁, assigns metadata values 00 to both chunk 0 and chunk 1. Based on this metadata, GPU 12 will fetch the texel values for chunk 0 from the system memory location associated with chunk 0. Likewise, GPU 12 will fetch the texel values for chunk 1 from the system memory location associated with chunk 1.

CPU 6 will assign metadata values of 10 for both chunk 2 and chunk 3. Such a metadata value indicates to GPU 12 to fetch the associated chunk from the system memory location associated with the chunk vertically next to the chunk. As such, GPU 12 will fetch chunk 2 from the system memory location associated with chunk 0, and will fetch chunk 3 from the system memory location associated with chunk 1. As both chunk 0 and chunk 1 would have previously been fetched and may be present in texture cache 41, chunk 2 and chunk 3 need not be fetched. Thus, 2:1 memory bandwidth compression is achieved.

In the example region 17₂, the top-side chunks 0 and 1 have the same texel values, while the bottom-side chunks 2 and 3 have the same texel values. As such, CPU 6, when analyzing region 17₂, assigns metadata values 00 to both chunk 0 and chunk 2. Based on this metadata, GPU 12 will fetch the texel values for chunk 0 from the system memory location associated with chunk 0. Likewise, GPU 12 will fetch the texel values for chunk 2 from the system memory location associated with chunk 2.

CPU 6 will assign metadata values of 01 for both chunk 1 and chunk 3. Such a metadata value indicates to GPU 12 to fetch the associated chunk from the system memory location associated with the chunk horizontally next to the chunk. As such, GPU 12 will fetch chunk 1 from the system memory location associated with chunk 0, and will fetch chunk 3 from the system memory location associated with chunk 2. As both chunk 0 and chunk 2 would have previously been fetched and may be present in texture cache 41, chunk 1 and chunk 3 need not be fetched. Thus, 2:1 memory bandwidth compression is achieved.

In the example of region 17₃, each of chunks 0-4 are different. That is, none of the chunks of region 17₃ have the same texel values. In this case, CPU 6 would assign a metadata value of 00 to each of the chunks. This metadata value indicates that each of the chunks are to be fetched from system memory locations associated with each respective chunk. In this example, no memory bandwidth compression is achieved.

Returning to FIG. 2, GPU 12 may be configured to access a metadata surface 13 associated with a texture surface 11, and fetch the texel data in texture surface 11 according to the metadata stored in metadata surface 13. Texture engine 39 may be configured to perform a texture filtering operation. Texture filtering is an operation used to determine a texture color value to use to map to a pixel value. To perform texture filtering, texture engine 39 of GPU 12 may first be configured to fetch a texture surface (e.g., texture surface 11A) from system memory 10.

In accordance with the techniques of this disclosure, texture engine 39 may first fetch metadata surface 13A associated with texture surface 11A. In one example, texture engine 39 may then be configured to read the metadata in metadata surface 13A for the chunks of one region of texture surface 11A. As discussed above, the metadata may include a pointer to a particular chunk in the region. This pointer indicates to texture engine 39 that the system memory location associated with the chunk pointed to by the metadata value is to be used to fetch the chunk.

Texture engine 39, e.g., using an internal or external memory management unit, will then fetch the chunk according to the metadata. For example, texture engine 39 will determine a location in system memory 10 of a first chunk of the first region as indicated by the metadata in the metadata surface. Based on this memory location, texture engine 39 will determine if the first chunk of the first region is already stored in texture cache 41. Based on a determination that the first chunk of the first region is not already stored in texture cache 41, texture engine 39 will fetch the first chunk of the first region and store it into texture cache 41. Based on a determination that the first chunk of the first region is already stored in texture cache 41, texture engine 39 will not fetch the first chunk of the first region into texture cache 41. This process is then repeated for all chunks of all regions of texture surface 11A.

In the above examples, regions of texture surface 11A are described as being divided into four chunks. However, CPU 6 may be configured to divide the regions of texture surface 11A into different arrangements, including arrangements that include more or fewer than four chunks. In such cases, CPU 6 may be configured to assign metadata to the metadata surface depending on the number of chunks in the region. For example, if CPU 6 divides regions of texture surface 11A into two or three chunks, the metadata may indicate whether the chunk is to be fetched as is or whether the chunk is to be fetched from a memory address associated with another chunk in the region. In examples where CPU 6 divides a region of texture surface 11A into more than four chunks, the metadata may indicate whether the chunk is to be fetched as is or whether the chunk is to be fetched from memory locations associated with neighboring chunks in the region (e.g., a memory address associated with a chunk vertically up, vertically down, horizontally left, or horizontally right relative to the current chunk).

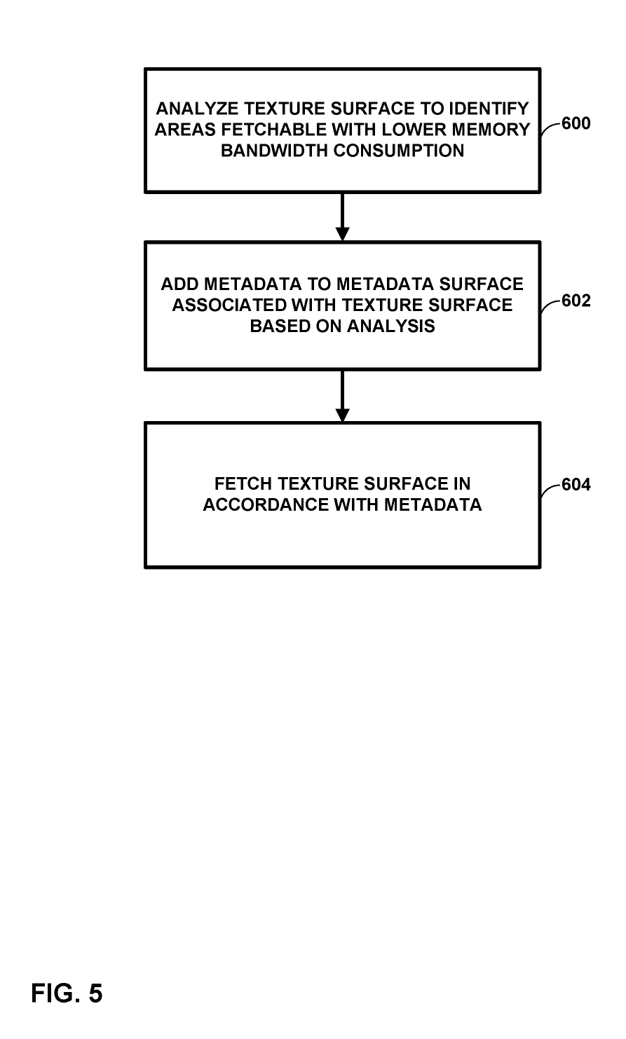

FIG. 5 is a flowchart showing an example method of the disclosure. The techniques of FIG. 5 may be performed by one or more of CPU 6 and GPU 12. As shown in FIG. 5, CPU 6 may be configured to analyze the texture surface to identify one or more areas of the texture surface that are fetchable with lower memory bandwidth consumption as compared to other areas of the texture surface (600). In some examples, CPU 6 may be configured to analyze the texture surface to identify one or more areas of the texture surface that are uniform with at least one other area of the texture surface. CPU 6 may further be configured to add metadata to the metadata surface associated with the texture surface based on the analysis, the metadata indicating the one or more areas of the texture surface that are fetchable with lower memory bandwidth consumption as compared to other areas of the texture surface (602). GPU 12 may then be configured to fetch the texture surface in accordance with the metadata (604).

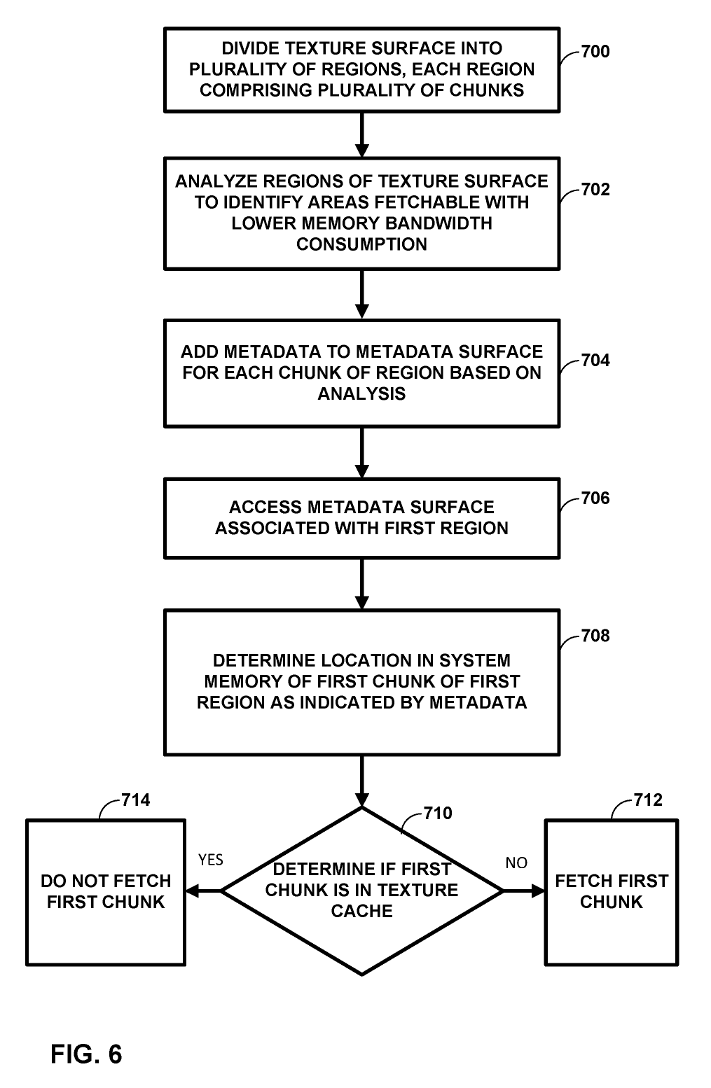

FIG. 6 is a flowchart showing another example method of the disclosure. The techniques of FIG. 6 may be performed by one or more of CPU 6 and GPU 12.

CPU 6 may be configured to divide the texture surface into a plurality of regions, each region comprising a plurality of chunks (700). CPU 6 may be configured to analyze regions of the texture surface to identify one or more areas of the texture surface that are fetchable with lower memory bandwidth consumption as compared to other areas of the texture surface (702). In some examples, CPU 6 may be configured to analyze the texture surface to identify one or more areas of the texture surface that are uniform with at least one other area of the texture surface. CPU 6 may be further configured to add metadata to the metadata surface for each of the plurality of respective chunks for each of the respective plurality of regions of the texture surface (704). In one example, the metadata for each chunk of a particular region of the plurality of regions comprises a pointer to one of the respective chunks of the particular region. In one example, each of the plurality of chunks are of a size less than or equal to a texture cache line size of the graphics processing unit.

In a particular example of the disclosure, a particular region comprises four chunks. The metadata for each of the four chunks is a 2-bit value, wherein the metadata has one of: a first 2-bit value indicating that a current chunk is fetched from a memory location corresponding to the current chunk, a second 2-bit value indicating that the current chunk is fetched from a memory location corresponding to a chunk located horizontally relative to the current chunk, a third 2-bit value indicating that the current chunk is fetched from a memory location corresponding to a chunk located vertically relative to the current chunk, or a fourth 2-bit value indicating that the current chunk is fetched from a memory location corresponding to a chunk located diagonally relative to the current chunk.

GPU 12 may be configured to access the metadata surface associated with a first region of the plurality of regions (706). GPU 12 may be further configured to determine a location in a system memory of a first chunk of the first region as indicated by the metadata in the metadata surface (708), and determine if the first chunk of the first region is already stored in a texture cache of the graphics processing unit based on the location in the system memory (710).

Based on a determination that the first chunk of the first region is not already stored in the texture cache of the graphics processing unit, GPU 12 may be configured to fetch the first chunk of the first region into the texture cache of the graphics processing unit (712). Based on a determination that the first chunk of the first region is already stored in the texture cache of the graphics processing unit, GPU 12 may be configured to not fetch the first chunk of the first region into the texture cache of the graphics processing unit (714).

Testing has shown that the memory bandwidth compression techniques of this disclosure may result in up to a 22% reduction in memory bandwidth usage. The techniques of this disclosure may further benefit from ease of implementation. Because the generated metadata surface is additional to the texture surface, the underlying texture surface is unchanged and no decompression/recompression is required. Furthermore, the memory bandwidth techniques of this disclosure may be used on top of other texture compression techniques.

Furthermore, as graphics driver 7 may be configured to generate the metadata, minimal additional hardware support is needed. Texture engine 39 need only be configured to access and read the generated metadata. The metadata surface may be read into an existing texture cache. Furthermore, while memory bandwidth consumption is reduced, cache space and power may be reduced as well, as multiple chunks may be stored in the same physical cache line (e.g., when chunks are indicated as being the same by the metadata).

In one or more examples, the functions described above may be implemented in hardware, software, firmware, or any combination thereof. If implemented in software, the functions may be stored as one or more instructions or code on an article of manufacture comprising a non-transitory computer-readable medium. Computer-readable media may include computer data storage media. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, cache memory, CD-ROM or other optical disk storage, magnetic disk storage, or other magnetic storage devices, flash memory, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more DSPs, general purpose microprocessors, ASICs, FPGAs, or other equivalent integrated or discrete logic circuitry. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for memory bandwidth compression, the method comprising:
analyzing a texture surface to identify one or more areas of the texture surface that are fetchable with lower memory bandwidth consumption as compared to other areas of the texture surface;
adding metadata to a metadata surface associated with the texture surface based on the analysis, the metadata indicating the one or more areas of the texture surface that are fetchable with lower memory bandwidth consumption as compared to other areas of the texture surface; and
fetching the texture surface in accordance with the metadata.

2. The method of claim 1, wherein analyzing the texture surface comprises analyzing the texture surface to identify one or more areas of the texture surface that are uniform with at least one other area of the texture surface.

3. The method of claim 1, further comprising:
dividing the texture surface into a plurality of regions, each region comprising a plurality of chunks, wherein the one or more areas of the texture surface that are fetchable with lower memory bandwidth consumption as compared to other areas of the texture surface include one or more the of the plurality of chunks; and
adding metadata to the metadata surface for each of the plurality of respective chunks for each of the respective plurality of regions of the texture surface.

4. The method of claim 3, wherein the metadata for each chunk of a particular region of the plurality of regions comprises a pointer to one of the respective chunks of the particular region.

5. The method of claim 4, wherein the particular region comprises four chunks, and wherein the metadata for each of the four chunks is a 2-bit value, wherein the metadata has one of:
a first 2-bit value indicating that a current chunk is fetched from a memory location corresponding to the current chunk,
a second 2-bit value indicating that the current chunk is fetched from a memory location corresponding to a chunk located horizontally relative to the current chunk,
a third 2-bit value indicating that the current chunk is fetched from a memory location corresponding to a chunk located vertically relative to the current chunk, or
a fourth 2-bit value indicating that the current chunk is fetched from a memory location corresponding to a chunk located diagonally relative to the current chunk.

6. The method of claim 3, wherein each of the plurality of chunks are of a size less than or equal to a texture cache line size of a graphics processing unit.

7. The method of claim 3, further comprising:
accessing, by a graphics processing unit, the metadata surface associated with a first region of the plurality of regions;
determining, by the graphics processing unit, a location in a system memory of a first chunk of the first region as indicated by the metadata in the metadata surface; and
determining, by the graphics processing unit, if the first chunk of the first region is already stored in a texture cache of the graphics processing unit based on the location in the system memory.

8. The method of claim 7, further comprising:
based on a determination that the first chunk of the first region is not already stored in the texture cache of the graphics processing unit, fetching the first chunk of the first region into the texture cache of the graphics processing unit.

9. The method of claim 7, further comprising:
based on a determination that the first chunk of the first region is already stored in the texture cache of the graphics processing unit, not fetching the first chunk of the first region into the texture cache of the graphics processing unit.

10. The method of claim 1, wherein analyzing the texture surface and adding the metadata to the metadata surface is performed by a processor executing a graphics driver for a graphics processing unit, and
wherein fetching the texture surface is performed by the graphics processing unit.

11. An apparatus comprising:
a system memory configured to store a texture surface and a metadata surface associated with the texture surface;
a processor in communication with the system memory, the processor configured to:
analyze the texture surface to identify one or more areas of the texture surface that are fetchable with lower memory bandwidth consumption as compared to other areas of the texture surface; and
add metadata to the metadata surface associated with the texture surface based on the analysis, the metadata indicating the one or more areas of the texture surface that are fetchable with lower memory bandwidth consumption as compared to other areas of the texture surface; and
a graphics processing unit in communication with the processor and the system memory, the graphics processing unit configured to:
fetch the texture surface in accordance with the metadata.

12. The apparatus of claim 11, wherein the processor is further configured to analyze the texture surface to identify one or more areas of the texture surface that are uniform with at least one other area of the texture surface.

13. The apparatus of claim 11, wherein the processor is further configured to:
divide the texture surface into a plurality of regions, each region comprising a plurality of chunks, wherein the one or more areas of the texture surface that are fetchable with lower memory bandwidth consumption as compared to other areas of the texture surface include one or more the of the plurality of chunks; and
add metadata to the metadata surface for each of the plurality of respective chunks for each of the respective plurality of regions of the texture surface.

14. The apparatus of claim 13, wherein the metadata for each chunk of a particular region of the plurality of regions comprises a pointer to one of the respective chunks of the particular region.

15. The apparatus of claim 14, wherein the particular region comprises four chunks, and wherein the metadata for each of the four chunks is a 2-bit value, wherein the metadata has one of:
a first 2-bit value indicating that a current chunk is fetched from a memory location corresponding to the current chunk,
a second 2-bit value indicating that the current chunk is fetched from a memory location corresponding to a chunk located horizontally relative to the current chunk,
a third 2-bit value indicating that the current chunk is fetched from a memory location corresponding to a chunk located vertically relative to the current chunk, or
a fourth 2-bit value indicating that the current chunk is fetched from a memory location corresponding to a chunk located diagonally relative to the current chunk.

16. The apparatus of claim 13, wherein each of the plurality of chunks are of a size less than or equal to a texture cache line size of the graphics processing unit.

17. The apparatus of claim 13, wherein the graphics processing unit is further configured to:
access the metadata surface associated with a first region of the plurality of regions;
determine a location in a system memory of a first chunk of the first region as indicated by the metadata in the metadata surface; and
determine if the first chunk of the first region is already stored in a texture cache of the graphics processing unit based on the location in the system memory.

18. The apparatus of claim 17, wherein the graphics processing unit is further configured to:
based on a determination that the first chunk of the first region is not already stored in the texture cache of the graphics processing unit, fetch the first chunk of the first region into the texture cache of the graphics processing unit.

19. The apparatus of claim 17, wherein the graphics processing unit is further configured to:
based on a determination that the first chunk of the first region is already stored in the texture cache of the graphics processing unit, not fetch the first chunk of the first region into the texture cache of the graphics processing unit.

20. The apparatus of claim 11, wherein the system memory, processor, and graphics process unit are part of a wireless device.

21. An apparatus comprising:
means for analyzing a texture surface to identify one or more areas of the texture surface that are fetchable with lower memory bandwidth consumption as compared to other areas of the texture surface;
means for adding metadata to a metadata surface associated with the texture surface based on the analysis, the metadata indicating the one or more areas of the texture surface that are fetchable with lower memory bandwidth consumption as compared to other areas of the texture surface; and
means for fetching the texture surface in accordance with the metadata.

22. The apparatus of claim 21, further comprising:
means for dividing the texture surface into a plurality of regions, each region comprising a plurality of chunks, wherein the one or more areas of the texture surface that are fetchable with lower memory bandwidth consumption as compared to other areas of the texture surface include one or more the of the plurality of chunks; and
means for adding metadata to the metadata surface for each of the plurality of respective chunks for each of the respective plurality of regions of the texture surface.

23. The apparatus of claim 22, wherein the metadata for each chunk of a particular region of the plurality of regions comprises a pointer to one of the respective chunks of the particular region.

24. The apparatus of claim 23, wherein the particular region comprises four chunks, and wherein the metadata for each of the four chunks is a 2-bit value, wherein the metadata has one of:
a first 2-bit value indicating that a current chunk is fetched from a memory location corresponding to the current chunk,
a second 2-bit value indicating that the current chunk is fetched from a memory location corresponding to a chunk located horizontally relative to the current chunk,
a third 2-bit value indicating that the current chunk is fetched from a memory location corresponding to a chunk located vertically relative to the current chunk, or
a fourth 2-bit value indicating that the current chunk is fetched from a memory location corresponding to a chunk located diagonally relative to the current chunk.

25. The apparatus of claim 22, further comprising:
means for accessing the metadata surface associated with a first region of the plurality of regions;
means for determining a location in a system memory of a first chunk of the first region as indicated by the metadata in the metadata surface; and
means for determining if the first chunk of the first region is already stored in a texture cache of the graphics processing unit based on the location in the system memory.

26. A computer-readable storage medium storing instructions that, when executed, cause one or more processors to:
analyze a texture surface to identify one or more areas of the texture surface that are fetchable with lower memory bandwidth consumption as compared to other areas of the texture surface;
add metadata to a metadata surface associated with the texture surface based on the analysis, the metadata indicating the one or more areas of the texture surface that are fetchable with lower memory bandwidth consumption as compared to other areas of the texture surface; and
fetch the texture surface in accordance with the metadata.

27. The computer-readable storage medium of claim 26, wherein the instructions further cause the one or more processors to:
divide the texture surface into a plurality of regions, each region comprising a plurality of chunks, wherein the one or more areas of the texture surface that are fetchable with lower memory bandwidth consumption as compared to other areas of the texture surface include one or more the of the plurality of chunks; and
add metadata to the metadata surface for each of the plurality of respective chunks for each of the respective plurality of regions of the texture surface.

28. The computer-readable storage medium of claim 27, wherein the metadata for each chunk of a particular region of the plurality of regions comprises a pointer to one of the respective chunks of the particular region.

29. The computer-readable storage medium of claim 28, wherein the particular region comprises four chunks, and wherein the metadata for each of the four chunks is a 2-bit value, wherein the metadata has one of:
a first 2-bit value indicating that a current chunk is fetched from a memory location corresponding to the current chunk,
a second 2-bit value indicating that the current chunk is fetched from a memory location corresponding to a chunk located horizontally relative to the current chunk,
a third 2-bit value indicating that the current chunk is fetched from a memory location corresponding to a chunk located vertically relative to the current chunk, or
a fourth 2-bit value indicating that the current chunk is fetched from a memory location corresponding to a chunk located diagonally relative to the current chunk.

30. The computer-readable storage medium of claim 27, wherein the instructions further cause the one or more processors to:
access the metadata surface associated with a first region of the plurality of regions;
determine a location in a system memory of a first chunk of the first region as indicated by the metadata in the metadata surface; and
determine if the first chunk of the first region is already stored in a texture cache of a graphics processing unit based on the location in the system memory.
